(19) United States
(12) Patent Application Publication
(10) Pub. No.: US 2016/0121655 A1
(43) Pub. Date: May 5, 2016

(54) Pneumatic Tire

(71) Applicant: THE YOKOHAMA RUBBER CO., LTD., Tokyo (JP)

(72) Inventors: Ryohei Okado, Hiratsuka-shi, Kanagawa (JP); Hideki Seto, Hiratsuka-shi, Kanagawa (JP)

(73) Assignee: The Yokohama Rubber Co., Ltd., Tokyo (JP)

(21) Appl. No.: 14/890,256

(22) PCT Filed: Apr. 18, 2014
(86) PCT No.: PCT/JP2014/061017

§ 371 Date: Nov. 10, 2015

(30) Foreign Application Priority Data
May 10, 2013 (JP) 2013-100254

(51) Int. Cl. B60C 5/14; B60C 1/00; B29D 30/06

(52) U.S. Cl. CPC B60C 5/14; B29D 30/0681; B60C 1/0008; B29D 2030/0682; B29K 2009/06

(57) ABSTRACT

The present technology provides a pneumatic tire having an inner liner comprising a film, which comprises thermoplastic resin or the thermoplastic resin composition of a thermoplastic resin blended with an elastomer, wherein a portion of the inner liner positioned in a region between bead filler tops at left and right sides, having a surface area less than 40% of a total surface area of the region is formed having a thickness of the inner liner thinner than a thickness of the other portion in the region.

### TECHNICAL FIELD

The present technology relates to a pneumatic tire. The present technology further relates to a pneumatic tire, with a reduced stiffness achieved by the reduction in a spring constant of the tire.

### BACKGROUND

A spring characteristic of a tire, which relates to riding comfort and a ground contact length, is an important consideration in tire development.

However, conventionally it has not been easy to manufacture tires varying the spring constant without restraint. Particularly, no effort has been made so far to reduce the spring constant of the tire after vulcanization molding and to reduce its stiffness to control riding comfort and the ground contact length.

The present technology relates to the reduction of the spring constant of a tire, via the reduction of the stiffness of a film configuring an inner liner. This is achieved by the topical formation of a thin portion in the inner liner of the pneumatic tire. The details are given below.

An technology in which durability of an inner liner can be improved by prohibiting its movement following the movement of a neighboring member has been proposed (Japanese Unexamined Patent Application Publication No. 2002-12003) which at first glance resembles the configuration of the present technology. According to this technology, improved durability can be achieved by disposing cuts in the inner liner in specified regions where the strain of the inner liner (air penetration preventing layer) may become large. However, the technical idea of the technology proposed by the Japanese Unexamined Patent Application Publication No. 2002-12003 is to dispose another second inner liner at the region where the cuts are made (See Paragraph 0019 in the Japanese Unexamined Patent Application Publication No. 2002-12003 and the like). There is no concept concerning the reduction of the spring constant or the stiffness of a tire and it is understood that the region thereof may have a larger stiffness.

Also, there has been another proposal in which multiple ridges or independent protrusions, which are set thicker than the neighboring regions, are formed on the surface of an inner liner of an unvulcanized tire. As a result, room is created for air to bleed out at a contact interface with a bladder to prevent the occurrence of air trapping (Japanese Unexamined Patent Application Publication No. 2006-35488). However, the technical idea of the technology of the proposal made in the Japanese Unexamined Patent Application Publication No. 2006-35488 is to dispose ridges and protrusions on the surface of the ordinary inner liner, which increases the spring constant and the stiffness of the tire rather than reducing them. Thus, the proposal is different from that of the present technology.

### SUMMARY

The present technology provides a pneumatic tire with a reduced stiffness achieved by reduction of the spring constant of the tire. Specifically, it provides a pneumatic tire, the spring constant of which can be reduced, thus the stiffness thereof can be adjusted and reduced, even after vulcanization molding.

A pneumatic tire of the present technology has the configuration described in (1) below.

(1) A pneumatic tire having an inner liner comprising a film, the film comprising a thermoplastic resin or a thermoplastic resin composition of a thermoplastic resin blended with an elastomer, wherein the inner liner located in a region between bead filler tops at left and right sides has a portion having a thickness of the inner liner formed thinner than a thickness of the other portion in the region, the portion having a surface area less than 40% of a total surface area of the inner liner in the region.

The pneumatic tire of the present technology according to the above is preferably configured as described in any of (2) to (8) below.

(2) The pneumatic tire according to (1) above, in which the thickness Gf of the inner liner in the portion having the thickness of the inner liner formed thin is in a range from 5 to 95% of the thickness Gs of the inner liner in the other portion in the region.

(3) The pneumatic tire according to (1) above, in which the thickness Gf of the inner liner in the portion having the thickness of the inner liner formed thin is in a range from 20 to 75% of the thickness Gs of the inner liner in the other portion in the region.

(4) The pneumatic tire according to any one of (1) to (3) above, in which the portion having the thickness of the inner liner formed thinner than the thickness of the other portion in the region is formed so as to not come into contact with an outer edge line of the inner liner.

(5) The pneumatic tire according to any one of (1) to (4) above, in which the inner liner has the portion having the thickness of the inner liner formed thinner than the thickness of the other portion at least in a region between a belt edge portion and the bead filler top.

(6) The pneumatic tire according to (5) above, in which the inner liner has the portion having the thickness of the inner liner formed thinner than the thickness of the other portion in the region, the portion having a surface area less than 30% of the total surface area of the inner liner in the region between the belt edge portion and the bead filler top.

(7) The pneumatic tire according to any one of (1) to (6) above, in which a process to form the portion of the inner liner having the thickness thinner than the other portion is a process that uses a laser.

(8) The pneumatic tire according to any one of (1) to (7) above, in which the process to form the portion of the inner liner having the thickness thinner than the thickness of the other portion is performed after vulcanization molding of the tire.

A pneumatic tire of the present technology according to claim 1 can provide a pneumatic tire with a reduced stiffness achieved by reduction of spring constant of the tire. Specifically, it can provide a pneumatic tire, the spring constant of which can be reduced, thus the stiffness thereof can be adjusted and reduced, even after vulcanization molding.

The pneumatic tire of the present technology according to any one of claims 2 to 8, can provide the benefits of the pneumatic tire of the present technology according to claim 1 more assuredly and certainly.

### BRIEF DESCRIPTION OF THE DRAWINGS

FIG. 1 is a partially fragmented perspective view illustrating an example of an embodiment of a pneumatic tire according to the present technology.

FIG. 2 is a cross-sectional view from the tire meridian direction, illustrating an example of an embodiment of the pneumatic tire according to the present technology.

FIG. 3 describes the pneumatic tire of the present technology, schematically illustrating various examples of the embodiments of the portions at which the inner liner thickness is formed thin disposed on the inner liner surface.

### DETAILED DESCRIPTION

A detailed explanation of the pneumatic tire of the present technology will be given below.

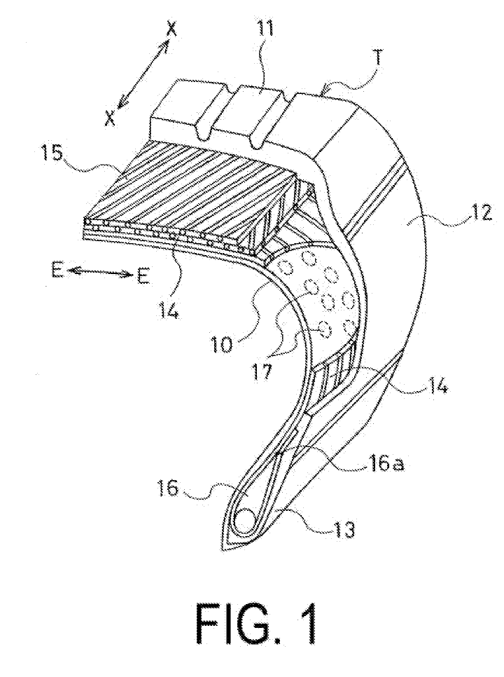

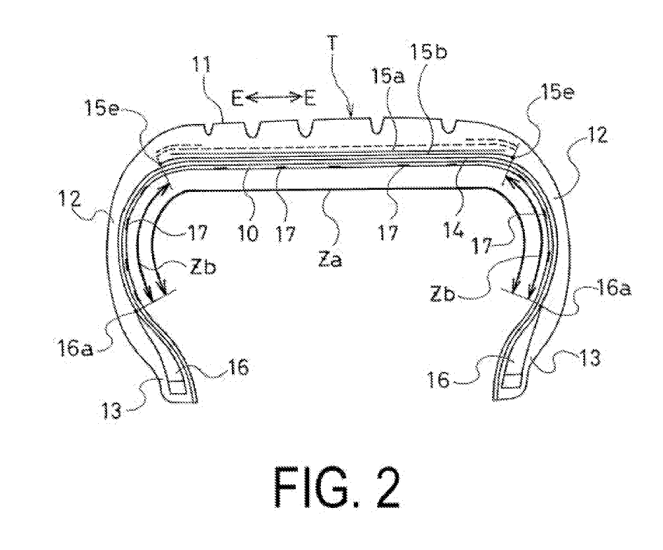

As illustrated in the examples of the embodiments schematically illustrated in FIG. 1 and FIG. 2, the pneumatic tire of the present technology is:

a pneumatic tire T having an inner liner 10 comprising a film, which comprises a thermoplastic resin or a thermoplastic resin composition of a thermoplastic resin blended with an elastomer, wherein the inner liner 10 located in a region Za between bead filler tops 16a at left and right sides has a portion 17 formed having a thickness of the inner liner thinner than a thickness of the other portion in the region Za, the portion having a surface area less than 40% of a total surface area of the inner liner 10 in the region.

In FIG. 1 and FIG. 2, a tire T is provided with a connected side wall portion 12 and bead portion 13 on the left and right of a tread portion 11. On the inner side of the tire, a carcass layer 14 that acts as a framework for the tire is provided so as to extend between the left and right bead portions 13, 13 in the tire width direction E. Bead fillers 16 are disposed on the tire outer circumference side of the bead portions 13. And the outermost circumferential point thereof is the bead filler top 16a.

The region extending between the bead filler tops 16a on the left and right sides is Za. The spring constant and stiffness of the tire in this region Za have an impact on the characteristics such as riding comfort and a ground contact length.

According to the present technology, topical reduction in thickness of the inner liner 10 reduces the stiffness of the film configuring the inner liner 10 and provides an isotropic material with anisotropy. As a result, it becomes possible to change the spring constant of a tire as a whole.

In addition, for the inner liner 10 positioned in region Za, which is the region between the bead filler tops 16a on the left and right sides, by limiting the surface area of the portion of the inner liner 10 with reduced thickness to less than 40% of the total surface area of the inner liner 10 within the region Za, it is possible to control the stiffness without affecting air leakage prevention properties even under severe conditions. It is not preferable to reduce the thickness of the inner liner for the surface area that is larger than 40% of the total surface area of the inner liner 10 within the region Za, because the air permeation preventive properties are degraded even though they may depend on the absolute value of the thickness itself.

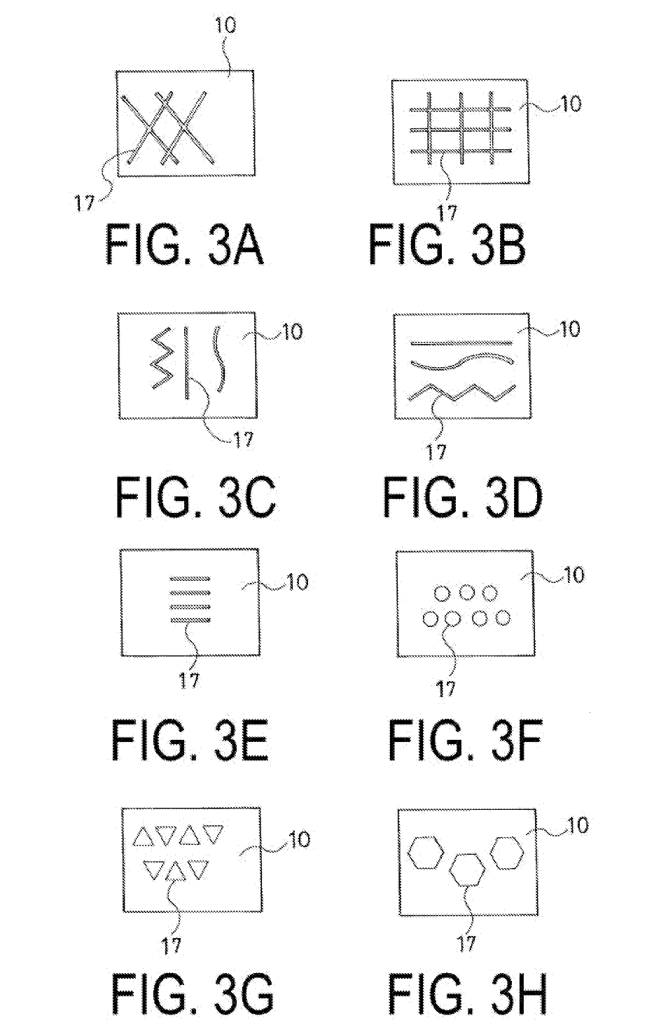

For the region Za between the bead filler tops on the left and right sides, there are variety of embodiments regarding the formation of the portion of the inner liner, which has the thickness formed thinner than the thickness of the other portion in the region Za. Examples are illustrated in FIG. 3 as the portion 17, in which the thickness of the inner liner is reduced. FIG. 3A illustrates an embodiment in which the oblique lines intersect each other. FIG. 3B illustrates an embodiment in which horizontal and vertical lines intersect each other. FIG. 3C illustrates an embodiment in which lines such as straight lines, curved lines and jagged lines extend in the radial direction of the tire. FIG. 3D illustrates an embodiment in which the lines such as straight lines, curved lines and jagged lines extend in the circumferential direction of the tire. FIG. 3E illustrates an embodiment in which lines are aligned intermittently. FIG. 3F illustrates an embodiment in which circular holes are aligned. FIG. 3G illustrates an embodiment in which triangles are aligned while the direction of their vertices alternating. FIG. 3H illustrates an embodiment in which polygons such as hexagons are aligned. Any of these embodiments may be used.

The thickness Gf of the inner liner in the portion that has the thickness of the inner liner formed thin, is preferably in a range from 5 to 95% of the thickness Gs of the inner liner in the other portion in the region. This is in order to achieve both reduction in stiffness and maintaining the air permeation preventive properties in a well-balanced manner. It is not preferable to make the thickness thinner than 5% or make through-holes, because it is difficult to maintain the air permeation preventive properties. It is not preferable to make the thickness thicker than 95%, because the difference in stiffness with the thick portion becomes insignificant and the overall effect of the tire spring constant reduction becomes insufficient.

From the viewpoint of obtaining both reduction in stiffness and maintaining the air permeation preventive properties in a well-balanced manner, the thickness Gf of the inner liner in the portion that has the thickness of the inner liner formed thin, is preferably in a range from 20 to 75% of the thickness Gs of the inner liner in the other portion in the region. It is preferable that the absolute value of the thickness itself is in a range from 50 to 250 μm, in order to maintain air permeation preventive properties of the inner liner. It is more preferable the value is in a range from 60 to 200 μm.

It is preferable that the portion 17 having the thickness of the inner liner formed thinner than the thickness of the other portion in the region Za, is formed so as to not come into contact with an outer edge line of the inner liner 10. It is not preferable that the portion 17 extends over the outer edge line of the inner liner 10, resulting in the variation in thickness of the inner liner, because its peripheral portions may become the starting point of cracks or delamination.

For the present technology to have a significant effect, it is preferable that, as illustrated in FIG. 2, the portion having the thickness of the inner liner formed thinner than the thickness of the other portion is present at least in the regions Zb, each of which is the region between the belt edge portion 15e and the bead filler top 16a of either the left or the right side. This is because the portion under the belt normally has a very large stiffness and reducing the thickness of the inner liner partially in the portion may not readily result in a change in the stiffness of the tire. It is the most effective to reduce the thickness of the inner liner partially in the region Zb between the belt edge portion 15e and the bead filler top 16a. In that case, it is preferable that, in the portion having a surface area less than 30% based on the total surface area of the inner liner in the region Zb between the belt edge portion 15e and the bead filler top 16a, the thickness of the inner liner is formed thinner than the thickness of the other portion. Because the region Zb is a region where the changes in the tire stiffness easily occur as described above, utilizing that region as a basis leads to the larger effect.

For the processing of forming the inner liner thickness thinner than the thickness of the other portion, processing using laser after vulcanization molding of the tire is relatively easy and so preferable. Particularly, the processing using laser is suitable for forming the thickness of inner liner thinner than the thickness of the other portion after the vulcanization molding of the tire and suitable for making a specific setting of the tire spring constant for an individual tire among the identical tires.

Specific examples include the laser processing in the tire width direction on the predetermined side (the surface of the tire cavity side) of the film that configures the inner liner. Namely, the thinner portion can be formed by the process in which the laser beam is irradiated and is incident on the inner liner surface (the film sheet surface) from the vertical direction thereof and is moved in the planer direction of the film-sheet material. This process using the laser beam is preferable because it is a non-contacting method.

The laser irradiation may be performed continuously while being moved, or may be performed intermittently while being moved. The process of irradiating the laser beam is most suitable, particularly because the depth of the portion to be formed thin (the thickness of the inner liner) can be adjusted by adjusting the velocity of motion and the intensity of the laser irradiation. As for the laser beam, the use of infrared laser or CO₂ (carbon dioxide) laser is preferable. Among these, CO₂ (carbon dioxide) laser is preferable from the viewpoint of good workability and controllability. The performance of YAG laser is dependent on the material of the film sheet material configuring the inner liner, and often inferior to the lasers described above from the viewpoint of workability and controllability.

When the thin portion is processed by the use of laser irradiation, it is not necessary to process the entire area of the region to be processed (the region processed to be thin) without any gap. The processing may be performed on the almost entire area of the region by ‘line drawing’, leaving some gaps partially. When the laser beam is used in the ‘line drawing’ manner to form the thin portion in the region of a substantial area, it is preferable to have a processing width (line width) of the laser beam in a range approximately from 0.2 to 1 mm.

The thermoplastic resin to be used in the present technology is preferably a polyamide resin [e.g., nylon 6 (N6), nylon 66 (N66), nylon 46 (N46), nylon 11 (N11), nylon 12 (N12), nylon 610 (N610), nylon 612 (N612), nylon 6/66 copolymer (N6/66), nylon 6/66/610 copolymer (N6/66/610), nylon MXD6 (MXD6), nylon 6T, nylon 9T, nylon 6/6T copolymer, nylon 66/PP copolymer, nylon 66/PPS copolymer] or an N-alkoxyalkyl compound thereof, e.g., a methoxymethyl compound of nylon 6, a methoxymethyl compound of a nylon 6/610 copolymer, or a methoxymethyl compound of nylon 612; a polyester resin [e.g., an aromatic polyester such as polybutylene terephthalate (PBT), polyethylene terephthalate (PET), polyethylene isophthalate (PEI), a PET/PEI copolymer, polyarylate (PAR), polybutylene naphthalate (PBN), a crystal polyester, a polyoxyalkylene diimide acid/polybutylene terephthalate copolymer]; a polynitrile resin [e.g., polyacrylonitrile (PAN), polymethacrylonitrile, an acrylonitrile/styrene copolymer (AS), a (meta) acrylonitrile/styrene copolymer, a (meta)acrylonitrile/styrene/butadiene copolymer], a polymethacrylate resin [e.g., polymethyl-methacrylate (PMMA), polyethyl-methacrylic acid], a polyvinyl resin [e.g., polyvinyl acetate, a polyvinyl alcohol (PVA), a vinyl alcohol/ethylene copolymer (EVOH), polyvinylidene chloride (PVDC), polyvinylchloride (PVC), a vinyl chloride/vinylidene chloride copolymer, a vinylidene chloride/methylacrylate copolymer, a vinylidene chloride/acrylonitrile copolymer (ETFE)], a cellulose resin [e.g., cellulose acetate, cellulose acetate butyrate], a fluoride resin [e.g., polyvinylidene difluoride (PVDF), polyvinyl fluoride (PVF), polychlorofluoroethylene (PCTFE), a tetrafluoroethylene/ethylene copolymer], or an imide resin [e.g., an aromatic polyimide (PI)].

Furthermore, in the thermoplastic resin and the elastomer that constitute the thermoplastic resin composition that can be used in the present technology, the above materials may be used as the thermoplastic resin. The elastomer to be used preferably includes a diene-based rubber or a hydrogenate thereof [e.g., natural rubber (NR), isoprene rubber (IR), epoxidized natural rubber, styrene butadiene rubber (SBR), butadiene rubber (BR, high cis-BR, low cis-BR), nitrile rubber (NBR), hydrogenated NBR, hydrogenated SBR], an olefin rubber [e.g., ethylene propylene rubber (EPDM, EPM), maleic acid modified ethylene propylene rubber (M-EPM), butyl rubber (IIR), an isobutylene and aromatic vinyl or diene-based monomer copolymer, acrylic rubber (ACM), an ionomer], a halogen-containing rubber [e.g., Br-IIR, CI-IIR, a brominated isobutylene-p-methylstyrene copolymer (BIMS), chloroprene rubber (CM), a hydrin rubber (CHR), chlorosulfonated polyethylene rubber (CSM), chlorinated polyethylene rubber (CM), chlorinated polyethylene rubber modified with maleic acid (M-CM)], a silicon rubber [e.g., methyl vinyl silicon rubber, dimethyl silicon rubber, methylphenyl vinyl silicon rubber], a sulfur-containing rubber [e.g., polysulfide rubber], a fluororubber [e.g., a vinylidene fluoride rubber, a vinyl ether rubber containing fluoride, a tetrafluoroethylene-propylene rubber, a silicon-based rubber containing fluoride, a phosphazene rubber containing fluoride], and a thermoplastic elastomer [e.g., a styrene elastomer, an olefin elastomer, an ester elastomer, a urethane elastomer, a polyamide elastomer].

Moreover, when the compatibility is different upon blending by combining the previously specified thermoplastic resin and the previously specified elastomer, a suitable compatibility agent may be used as a third component to enable compatibilization of both the resin and the elastomer. By mixing the compatibility agent in the blend, interfacial tension between the thermoplastic resin and the elastomer is reduced, and as a result, the particle diameter of the elastomer that forms the dispersion phase becomes very small and thus the characteristics of both components may be realized effectively. In general, such a compatibility agent has a copolymer structure of both or either the thermoplastic resin and the elastomer, or a copolymer structure having an epoxy group, a carbonyl group, a halogen group, an amino group, an oxazoline group, or a hydroxyl group, which is capable of reacting with the thermoplastic resin or the elastomer. While the type of compatibility agent may be selected according to the type of thermoplastic resin and elastomer to be blended, such a compatibility agent generally includes: a styrene/ethylene butylene block copolymer (SEBS) or a maleic acid modified compound thereof; a EPDM, EPM, EPDM/styrene or EPDM/acrylonitrile graft copolymer or a maleic acid modified compound thereof; a styrene/maleic acid copolymer, or a reactive phenoxy, and the like. The blending quantity of such a compatibility agent, while not being limited, is preferably 0.5 to 10 parts by weight with respect to 100 parts by weight of the polymer component (total of the thermoplastic resin and the elastomer).

A composition ratio of the specific thermoplastic resin and the elastomer in the thermoplastic resin composition of a thermoplastic resin blended with an elastomer, while not limited in particular, may be determined as appropriate to establish a dispersed structure as a discontinuous phase of the elastomer in the matrix of the thermoplastic resin, and is preferably a range of a weight ratio of 90/10 to 30/70.

In the present technology, a compatibility agent or other polymers within a range that does not harm the characteristics required for an inner liner may be blended with the thermoplastic resin or the thermoplastic resin composition of a thermoplastic resin blended with an elastomer. The purposes of mixing such a polymer are to improve the compatibility between the thermoplastic resin and the elastomer, to improve the molding processability of the material, to improve the heat resistance, to reduce cost, and so on. Examples of the material used for the polymer include polyethylene (PE), polypropylene (PP), polystyrene (PS), ABS, SBS, and polycarbonate (PC).

Furthermore, the elastomer can be dynamically vulcanized when being mixed in with the thermoplastic resin. A vulcanizer, a vulcanization assistant, vulcanization conditions (temperature, time), and the like, during the dynamic vulcanization can be determined as appropriate in accordance with the composition of the elastomer to be added, and are not particularly limited.

Furthermore, a reinforcing agent such as a filler (calcium carbonate, titanium oxide, alumina, and the like), carbon black, or white carbon, a softening agent, a plasticizer, a processing aid, a pigment, a dye, an anti-aging agent, or the like generally compounded with polymer compounds may be optionally compounded so long as the characteristics required for an inner liner are not harmed. The thermoplastic resin composition has a structure in which the elastomer is distributed as a discontinuous phase in the matrix of the thermoplastic resin. By having such a structure, it becomes possible to provide the inner liner with sufficient flexibility and sufficient stiffness that is attributed to the effect of the resin layer as a continuous phase. Furthermore, it becomes possible to obtain, during molding, a molding workability equivalent to that of the thermoplastic resin regardless of the amount of the elastomer.

The Young's moduli of the thermoplastic resin and the elastomer that can be used in the present technology are not particularly limited, and are preferably set to 1 to 500 MPa, and more preferably 50 to 500 MPa.

### Examples

The specific configuration and effect of the pneumatic tire of the present technology are described below using examples.

### Working Examples 1 to 6, Comparative Example 1

195/65R15 tires were used as test tires. Five specimens were prepared for each Working Examples 1 to 6 and the Comparative Example 1, and evaluated according to the evaluation methods below.

### (1) Air Permeation Test (Rate of Pressure Decrease)

The specimens were left for three months, with an initial air pressure of 200 kPa, at room temperature of 21° C., and under a no-load condition. The interval of the inner pressure measurement was every 4 days. The value of α was obtained by regression from the following equation, where P1, P0, and t represent a measured pressure, the initial pressure, and the number of days elapsed, respectively.

(P1/P0)=exp(−αt)

Then, using the value of α obtained, β, a rate of pressure decrease per month (%/month) was obtained from the equation, (β(%/month)=(1−exp(−αt))×100, assigning 30 (days) to the value t. The results were expressed in index relative to the comparative example 1 as 100. A larger value of β indicates less air permeation (leakage) and better performance.

### (2) Riding Comfort

Pneumatic tires were assembled on the rims of the size 15×6JJ, inflated to the air pressure of 230 kPa and mounted on a 2-liter domestic test vehicle. Five trained test drivers graded sensory feel of the riding comfort during the driving on the test course. The average grades were evaluated. The results obtained were indexed with the index value of Comparative Example 1 being 100. Larger index values indicate superior riding comfort.

For the Working Example 1 to 6 and the Comparative Example 1, the thermoplastic resin composition configuring the inner liner contained the ingredients listed in Table 1, and was a film with the thickness of 200 μm.

The details as well as the evaluation results of the Working Examples 1 to 6 and the Comparative Example 1 are listed in Table 2.

The pneumatic tire of the present technology exhibited the superior riding comfort, as well as superior performance against air leakage.

TABLE 1

| | | Parts by |
|---|---|---|
| | | mass |
| BIMS^{a)} | “Exxpro 3035” made by ExxonMobile Chemical | 100 |
| | Co. | |
| Zinc oxide | “Zinc white type III” made by Seido Chemical | 0.5 |
| | Industry Co., Ltd. | |
| Stearic acid | Industrial stearic acid | 0.2 |
| Zinc stearate | “Zinc stearate” made by NOF Corporation | 1 |
| N6/66 | “UBE Nylon 5033B” manufactured by Ube | 100 |
| | Industries, Ltd. | |
| Modified | “HPR-AR201” made by Dupont-Mitsui | 10 |
| EEAb) | Polychemicals Co., Ltd. | |

Remarks:
^{a)}A brominated isobutylene-p-methylstyrene copolymer
b)Maleic anhydride-modified ethylene-ethylacrylate copolymer

TABLE 2

| | Comparative | Working | Working | Working | Working | Working | Working |
|---|---|---|---|---|---|---|---|
| | Example 1 | Example 1 | Example 2 | Example 3 | Example 4 | Example 5 | Example 6 |
| The thickness at | — | 5% | 5% | 5% | 25% | 75% | 95% |
| the thin portion (%) | (100%) | | | | | | |
| Surface area of | — | 40% | 30% | 5% | 5% | 5% | 5% |
| the thin portion/ | (0%) | | | | | | |
| total surface area (%) | | | | | | | |
| The configuration | — | FIG. 3F | FIG. 3B | FIG. 3A | FIG. 3A | FIG. 3A | FIG. 3A |
| at the thin portion (%) | | | | | | | |
| Riding Comfort Index | 100 | 104 | 103 | 102 | 103 | 103 | 103 |
| Air Permeability Index | 100 | 100 | 100 | 100 | 100 | 100 | 100 |

1. A pneumatic tire having an inner liner comprising a film, the film comprising a thermoplastic resin or a thermoplastic resin composition of a thermoplastic resin blended with an elastomer, wherein the inner liner located in a region between bead filler tops at left and right sides has a portion having a thickness of the inner liner formed thinner than a thickness of the other portion in the region, the portion having a surface area less than 40% of a total surface area of the inner liner in the region.

2. The pneumatic tire according to claim 1, wherein the thickness Gf of the inner liner in the portion having the thickness of the inner liner formed thin is in a range from 5 to 95% of the thickness Gs of the inner liner in the other portion in the region.

3. The pneumatic tire according to claim 1, wherein the thickness Gf of the inner liner in the portion having the thickness of the inner liner formed thin is in a range from 20 to 75% of the thickness Gs of the inner liner in the other portion in the region.

4. The pneumatic tire according to claim 1, wherein the portion having the thickness of the inner liner formed thinner than the thickness of the other portion in the region is formed so as to not come into contact with an outer edge line of the inner liner.

5. The pneumatic tire according to claim 1, wherein the inner liner has the portion having the thickness of the inner liner formed thinner than the thickness of the other portion at least in a region between a belt edge portion and the bead filler top.

6. The pneumatic tire according to claim 5, wherein the inner liner has the portion having the thickness of the inner liner formed thinner than the thickness of the other portion in the region, the portion having a surface area less than 30% of the total surface area of the inner liner in the region between the belt edge portion and the bead filler top.

7. The pneumatic tire according to claim 1, wherein a process to form the portion of the inner liner having the thickness thinner than the other portion is a process that uses a laser.

8. The pneumatic tire according to claim 1, wherein the process to form the portion of the inner liner having the thickness thinner than the thickness of the other portion is performed after vulcanization molding of the tire.

9. The pneumatic tire according to claim 2, wherein the portion having the thickness of the inner liner formed thinner than the thickness of the other portion in the region is formed so as to not come into contact with an outer edge line of the inner liner.

10. The pneumatic tire according to claim 9, wherein the inner liner has the portion having the thickness of the inner liner formed thinner than the thickness of the other portion at least in a region between a belt edge portion and the bead filler top.

11. The pneumatic tire according to claim 10, wherein the inner liner has the portion having the thickness of the inner liner formed thinner than the thickness of the other portion in the region, the portion having a surface area less than 30% of the total surface area of the inner liner in the region between the belt edge portion and the bead filler top.

12. The pneumatic tire according to claim 11, wherein a process to form the portion of the inner liner having the thickness thinner than the other portion is a process that uses a laser.

13. The pneumatic tire according to claim 12, wherein the process to form the portion of the inner liner having the thickness thinner than the thickness of the other portion is performed after vulcanization molding of the tire.
